(19) United States
(12) Patent Application Publication
(10) Pub. No.: US 2005/0240304 A1
(43) Pub. Date: Oct. 27, 2005

(54) Method and apparatus for automatic health monitoring

(76) Inventors: Matthew York, Blackstone, VA (US); Thomas Alfred Largi, Clifton, NJ (US); Paul A. Kuwik, Wexford, PA (US); Dennis J. Crump, Oakton, VA (US); David L. Livingston, Salem, VA (US); James C. Squire, Buena Vista, VA (US)

Correspondence Address: MacLane C. Key;MacLane C. Key, Inc, 12329 Antietam Road, Lake Ridge, VA, 22192, US

(21) Appl. No.: 10/828,491

(22) Filed: Apr. 21, 2004

(51) Int. Cl. G06F 17/00

(52) U.S. Cl. 700/242

(57) ABSTRACT

Embodiments of the present invention are directed to a method and apparatus for automatic health monitoring. In one embodiment, a regularly accessed device is equipped with an access detection unit. In one embodiment, a regularly accessed device is a temperature controlled compartment. In one embodiment, a timer is started when the access detection unit detects an access to the temperature controlled compartment. In one embodiment, a determination unit determines whether a second access is made within a time interval of a first access. In one embodiment, the time interval is determined using the patient's recommended medication regimen. In one embodiment, when a determination unit determines that a second access is not made within a time interval of a first access, a signal generator generates a signal. In one embodiment, the signal is transmitted to a healthcare provider. In one embodiment, the signal is transmitted via a computer network.

### BACKGROUND OF THE INVENTION

1. Field of the Invention

The present invention relates to the field of patient monitoring, and in particular to a method and apparatus for automatic health monitoring.

2. Background Art

Patients are frequently directed by a medical professional to take medications, drugs, vitamins, supplements, injections, or other substances at some interval. However, too frequently, patients fail to comply with the recommendations of the medical professional. Such failures can have seriously detrimental health consequences for a patient, so systems and devices have been created to help ensure that patients receive the correct substance at the correct time. However, these systems and devices tend to be intrusive, expensive, insufficient for certain medications, and/or otherwise inefficient.

Further, some patients are at risk of becoming injured, incapacitated, and/or otherwise in need of medical assistance without having another person present to notify medical authorities. However, systems created to address this problem typically require a patient to always carry a notification transmitting device.

### SUMMARY OF THE INVENTION

Embodiments of the present invention are directed to a method and apparatus for automatic health monitoring. In one embodiment, a regularly accessed device (e.g., a household appliance, a television, a computer, etc.) is equipped with an access detection device. In one embodiment of the present invention, a temperature controlled compartment is equipped with an access detection unit. In one embodiment, the temperature controlled compartment maintains a temperature within a portion of the compartment within a range of temperatures. In one embodiment, the temperature controlled compartment maintains a temperature at a specific temperature. In another embodiment, the temperature controlled compartment is a refrigeration unit. In one embodiment, the temperature controlled compartment makes use of one or more solid-state Peltier junctions.

In one embodiment, an access detection unit detects when a door, window, or other access means of the temperature controlled compartment is opened. In another embodiment, the access detection unit detects when a door, window, or other access means of the temperature controlled compartment is closed. In various embodiments, opening and/or closing the door, window, or other access means of the temperature controlled compartment opens or closes a circuit. In another embodiment, the access detection unit senses a change in the environment that results from the temperature controlled compartment being accessed. In one embodiment, the access detection unit senses a temperature change. In another embodiment, the access detection unit senses a light intensity change. In another embodiment, the access detection unit senses a change in the atmosphere within the compartment.

In one embodiment, a timer is started when the access detection unit detects an access to the temperature controlled compartment. In one embodiment, the timer increments a value. In another embodiment, the timer decrements a value. In one embodiment, a determination unit determines whether a second access to the temperature controlled compartment is made within a time interval of a first access to the temperature controlled compartment. In one embodiment, when the timer reaches a trigger value, the determination unit determines that a second access to the temperature controlled compartment is not made within a time interval of a first access to the temperature controlled compartment.

In one embodiment, the time interval is determined using the patient's recommended medication regimen. In one embodiment, the time interval is determined from the number of doses to be consumed per day. In another embodiment, the time interval is determined from the number of doses to be consumed during hours in which the patient is awake and/or active. In still another embodiment, the time interval is determined by calculating the length of time that will lapse before the level of a medication in the patient's system would reach a triggering level (i.e., the level at which more medication should be taken). In one embodiment, a time interval determiner utilizes patient data (e.g., weight, age, activity level, sex, etc.) to determine the time interval. In still another embodiment, a time interval determiner utilizes medication data (e.g., equations, data, and/or graphs of the level of medication in a patient with respect to time and/or other factors).

In one embodiment, when a determination unit determines that a second access to the temperature controlled compartment is not made within a time interval of a first access to the temperature controlled compartment, a signal generator generates a signal. In one embodiment, the signal is an audio signal. In another embodiment, the signal is a visual signal. In yet another embodiment, the signal is a tactile signal (e.g., vibration). In still another embodiment, the signal is odiferous. In another embodiment, the signal is electronic. In one embodiment, a backup power supply is provided. In one embodiment, the backup power supply is a battery.

In one embodiment, the signal is transmitted to a healthcare provider (e.g., a doctor, nurse, nurse practitioner, relative, and/or other individual or organization that monitors a patient's compliance with a medical regimen). In one embodiment, the signal is transmitted via a computer network. In one embodiment, the signal is transmitted via the Internet. In still another embodiment, the signal is transmitted at least in part via a wireless connection. In another embodiment, the signal is delivered at least in part to a speaker (e.g., a pre-recorded message sent telephonically to a healthcare provider's telephonic device). In one embodiment, the signal is delivered at least in part to a personal data assistant. In one embodiment, the signal is delivered to a device that analyzes the signal and takes an appropriate action (e.g., generating and transmitting additional signals). In various other embodiments, the signal is delivered via pager, switchboard monitoring center, instant messaging, electronic mail, cell phone, encrypted radio broadcast, dedicated connection, and/or any other electronic communications means.

In one embodiment, when a primary power source fails and the backup power source is in use, a signal is generated and transmitted in a manner similar to the signal generated when a second access to the temperature controlled compartment is not made within a time interval of a first access to the temperature controlled compartment.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of controlling the temperature within the temperature controlled compartment in accordance with one embodiment of the present invention.

FIG. 2 is a flow diagram of the process of detecting access to a temperature controlled compartment wherein opening an access panel closes a circuit in accordance with one embodiment of the present invention.

FIG. 3 is a flow diagram of the process of determining whether a second access to a temperature controlled compartment is made within a time interval of a first access to the temperature controlled compartment in accordance with one embodiment of the present invention.

FIG. 4 is a flow diagram of the process of determining a time interval in accordance with one embodiment of the present invention.

FIG. 5 is a flow diagram of the process of determining a time interval utilizing patient and medication data in accordance with one embodiment of the present invention.

FIG. 6 is a flow diagram of the process of signaling patient non-compliance in accordance with one embodiment of the present invention.

FIG. 7 is a flow diagram of the process of notifying a healthcare provider of a patient's non-compliance in accordance with one embodiment of the present invention. At block 700, a patient is supplied with a medical regimen.

FIG. 8 is a diagram of the flow of occurrences involved in monitoring patient compliance with a medication regimen in accordance with one embodiment of the present invention.

FIG. 9 is a flow diagram of the process of powering a patient compliance monitoring system in accordance with the present invention.

FIG. 10 is a block diagram of an example embodiment wherein a temperature controlled compartment is placed within a typical household refrigerator in accordance with one embodiment of the present invention.

FIG. 11 is a block diagram of an alternative example embodiment wherein the temperature controlled compartment need not be placed within a typical household refrigerator in accordance with one embodiment of the present invention.

FIG. 12 is a block diagram of a general purpose computer in accordance with one embodiment of the present invention.

### DETAILED DESCRIPTION OF THE INVENTION

The invention is a method and apparatus for automatic health monitoring. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention. All words, terms, and phrases in the specification, drawings, and claims are intended to be interpreted as broadly as possible without causing the claims to be anticipated by or obvious in view of the prior art.

Regularly Accessed Device

In one embodiment, a regularly accessed device (e.g., a household appliance, a television, a computer, refrigerator, stove, microwave, etc.) is equipped with an access detection device. In one embodiment, a regularly accessed device need not be a device that is accessed on a rigid schedule. In one embodiment, a regularly accessed device is a device that is accessed with a substantially predictable frequency. In one embodiment, if, after a first access is made to the regularly accessed device, a second access is not made within a time period, a signal is sent to a healthcare provider. In one embodiment, failure to make a second access within the time period is an indicator that the individual being monitored may be in need of assistance.

In one embodiment, the time period is determined in accordance with the regularity with which the device is accessed. In another embodiment, accesses to more than one device are monitored, and an access to any device is treated as a second access with respect to the previously accessed device. In one such embodiment, the time period is determined in accordance with the regularity of accessing any of the monitored devices.

In an example embodiment, an independent, elderly woman lives on her own. One or more of her regularly used devices (e.g., her refrigerator, freezer, television, radio, oven, toilet, faucet, motion-sensing lights, etc.) are equipped with an access detection unit. Her usage patterns are determined, and one or more time periods are determined accordingly. Then, if the woman's usage pattern indicates a problem (e.g., she has failed to access her toilet for two days, no motion sensing lights have activated in the evening for two days, a refrigerator is not accessed for six hours, etc.), someone is alerted to the situation (e.g., an adult child, a friend, a church leader, a monitoring service, etc.).

Temperature Controlled Compartment

In one embodiment of the present invention, a regularly accessed devices is a temperature controlled compartment. In one embodiment, a temperature controlled compartment is equipped with an access detection unit. In one embodiment, the temperature controlled compartment maintains a temperature within a portion of the compartment within a range of temperatures. In one embodiment, the temperature controlled compartment maintains a temperature at a specific temperature. In another embodiment, the temperature controlled compartment is a refrigeration unit. In one embodiment, the temperature controlled compartment makes use of one or more solid-state Peltier junctions.

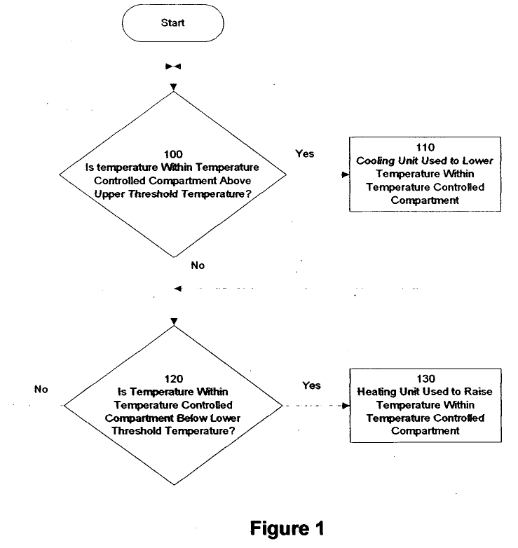

FIG. 1 illustrates the process of controlling the temperature within the temperature controlled compartment in accordance with one embodiment of the present invention. At block 100, it is determined whether the temperature within the temperature controlled compartment is above an upper threshold temperature. If the temperature within the temperature controlled compartment is above an upper threshold temperature, at block 110, a cooling unit is used to lower the temperature within the temperature controlled compartment, and the process repeats at block 100.

If the temperature within the temperature controlled compartment is not above an upper threshold temperature, at block 120, it is determined whether the temperature within the temperature controlled compartment is below a lower threshold temperature. If the temperature within the temperature controlled compartment is below a lower threshold temperature, at block 130, a heating unit is used to raise the temperature within the temperature controlled compartment, and the process repeats at block 120. If the temperature within the temperature controlled compartment is not below a lower threshold temperature, the process repeats at block 100.

In various embodiments, only a heating unit is provided or only a cooling unit is provided for temperature control. In these embodiments, the temperature controlled compartment is only controlled insofar as to prevent the temperature within the temperature controlled compartment from rising above a specific temperature or from falling below a specific temperature.

In various embodiments, the temperature controlled compartment is of various sizes. In one embodiment, the temperature controlled compartment approximately the size of a standard refrigerator for home use. In another embodiment, the temperature controlled compartment is small enough to fit within a standard refrigerator.

Access Detection Unit

In one embodiment, an access detection unit detects when a door, window, or other access means of the temperature controlled compartment is opened. In one embodiment, a switch of the type used to control a light inside a refrigerator is used to detect an access to the temperature controlled compartment. In another embodiment, the access detection unit detects when a door, window, or other access means of the temperature controlled compartment is closed. In various embodiments, opening and/or closing the door, window, or other access means of the temperature controlled compartment opens or closes a circuit.

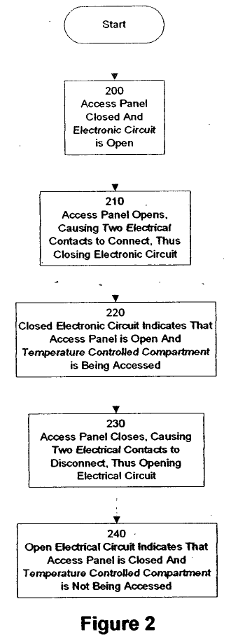

FIG. 2 illustrates the process of detecting access to a temperature controlled compartment wherein opening an access panel closes a circuit in accordance with one embodiment of the present invention. At block 200, the access panel is closed and an electronic circuit is open. At block 210, the access panel opens, causing two electrical contacts to connect, thus closing an electronic circuit. At block 220, the closed electronic circuit indicates that the access panel is open and the temperature controlled compartment is being accessed. At block 230, the access panel closes, causing the two electrical contacts to disconnect, thus opening the electrical circuit. At block 240, the open electrical circuit indicates that the access panel is closed and the temperature controlled compartment is not being accessed.

In one embodiment, after an access to the temperature controlled compartment, the compartment contents are analyzed to determine whether anything was removed during the access. In one embodiment, the contents are positioned within one or more measured containers. In one embodiment, it is determined that something was removed during an access when a measured container that housed a substance before the access no longer houses a substance. In one embodiment, the amount of a substance in the measured container before the access is known, and thus the amount removed during the access is known. In another embodiment, a substance is contained in an apparatus within the temperature controlled compartment wherein the apparatus determines the amount of substance removed during an access (e.g., by weighting the substance before and after accesses). In various other embodiments, other known methods of inventorying container contents (e.g., bar codes, computer image analysis, radiological tags, etc.) are used to determine how much of a substance is removed during an access.

In another embodiment, the access detection unit senses a change in the environment that results from the temperature controlled compartment being accessed. In one embodiment, the access detection unit senses a temperature change. In another embodiment, the access detection unit senses a light intensity change. In another embodiment, the access detection unit senses a change in the atmosphere within the compartment.

In an example embodiment, the temperature controlled compartment is filled exclusively with a chemically inert gas to better preserve the contents of the temperature controlled compartment. When the compartment is accessed, atmospheric impurities (e.g., air) enter the temperature controlled compartment and the access detection unit detects the altered gas composition within the temperature controlled compartment. Thus, the access detection unit detects an access. Once the access is complete, the temperature controlled compartment is again filled exclusively with a chemically inert gas.

In one embodiment, the access detection unit detects accesses to the temperature controlled compartment by detecting movement of the temperature controlled department. In an example embodiment, the temperature controlled compartment is placed within a standard refrigerator. When the temperature controlled compartment is removed from the refrigerator, the access detection unit detects the removal and indicates that the temperature controlled compartment has been accessed. Various embodiments, different methods are employed to detect removal of the temperature controlled compartment (e.g., a base with the ability to detect the presence and/or absence of the temperature controlled compartment remains in the refrigerator, a proximity sensing system, etc.). In one embodiment, control of the temperature within the temperature controlled compartment is implemented using the refrigerator in which the temperature controlled compartment is placed.

Timer

In one embodiment, a timer is started when the access detection unit detects an access to the temperature controlled compartment. In one embodiment, the timer increments a value. In another embodiment, the timer decrements a value. In one embodiment, a determination unit determines whether a second access to the temperature controlled compartment is made within a time interval of a first access to the temperature controlled compartment. In one embodiment, when the timer reaches a trigger value, the determination unit determines that a second access to the temperature controlled compartment is not made within a time interval of a first access to the temperature controlled compartment.

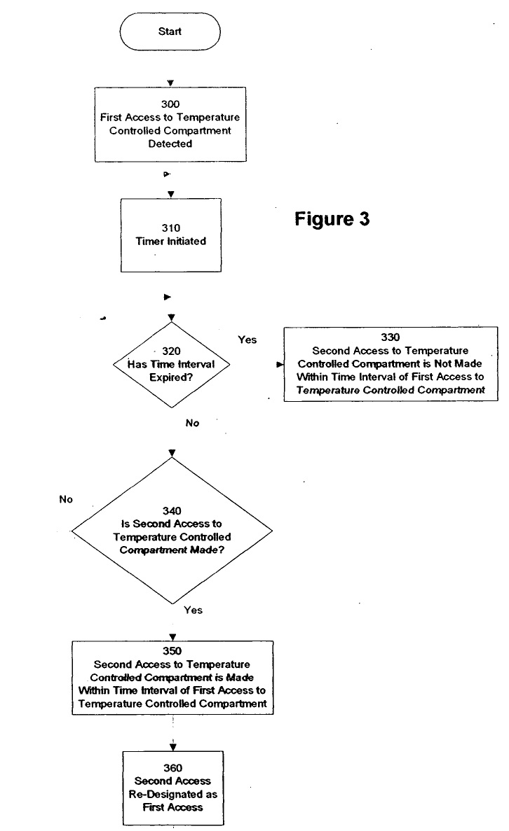

FIG. 3 illustrates the process of determining whether a second access to a temperature controlled compartment is made within a time interval of a first access to the temperature controlled compartment in accordance with one embodiment of the present invention. At block 300, a first access to a temperature controlled compartment is detected. At block 310, a timer is initiated. At block 320, it is determined whether a time interval has expired. If the time interval has expired, at block 330, a second access to the temperature controlled compartment is not made within the time interval of the first access to the temperature controlled compartment.

If the time interval has not expired, at block 340, it is determined whether a second access to the temperature controlled compartment is made. If a second access to the temperature controlled compartment is not made, the process repeats at block 320. If a second access to the temperature controlled compartment is made, at block 350, a second access to the temperature controlled compartment is made within the time interval of the first access to the temperature controlled compartment. At block 360, the second access is re-designated as the first access, and the process repeats at block 310.

Determination of Time Interval

In one embodiment, the time interval is determined using the patient's recommended medication regimen. In one embodiment, the time interval is determined from the number of doses to be consumed per day. In another embodiment, the time interval is determined from the number of doses to be consumed during hours in which the patient is awake and/or active.

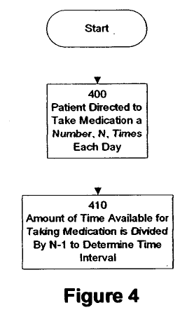

FIG. 4 illustrates the process of determining a time interval in accordance with one embodiment of the present invention. At block 400, a patient is directed to take a medication a number, n, times each day. At block 410, the amount of time available for taking the medication is divided by n-1 to determine the time interval. In an example embodiment, when a patient is to take a medication three times a day and the patient is awake approximately 16 hours each day, the time interval is eight hours.

In still another embodiment, the time interval is determined by calculating the length of time that will lapse before the level of a medication in the patient's system would reach a triggering level (i.e., the level at which more medication should be taken). In one embodiment, a time interval determiner utilizes patient data (e.g., weight, age, activity level, sex, etc.) to determine the time interval. In still another embodiment, a time interval determiner utilizes medication data (e.g., equations, data, and/or graphs of the level of medication in a patient with respect to time and/or other factors).

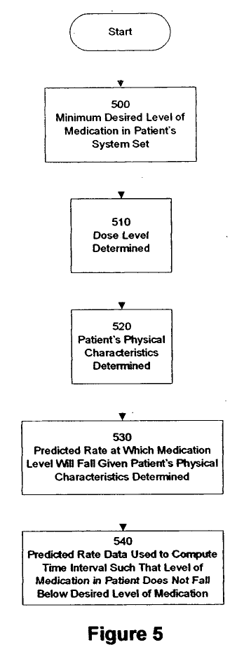

FIG. 5 illustrates the process of determining a time interval utilizing patient and medication data in accordance with one embodiment of the present invention. At block 500, a minimum desired level of medication in a patient's system is set (e.g., by a healthcare provider). At block 510, the dose level is determined. At block 520, the patient's physical characteristics (e.g., weight, sex, body composition, race, etc.) are determined.

At block 530, the predicted rate at which the medication level will fall given the patient's physical characteristics is determined. In one embodiment, the predicted rate is determined by accessing a database and retrieving rate data corresponding to the medication and the patient's physical characteristics. In one embodiment, the rate is expressed as a function with respect to time. It will be understood by one of ordinary skill in the art that the predicted rate will, in various embodiments, necessarily have some error when compared with the actual rate.

At block 540, the predicted rate data is used to compute a time interval such that the level of medication in a patient does not fall below the desired level of medication. In one embodiment, the time interval calculation also utilizes a predicted rate at which the medication level will rise once the dose is taken. In another embodiment, when the temperature controlled compartment is accessed, a record is made that a dose of medication has been taken. In one embodiment, the predicted level of medication in a patient given the previous dose compliance record is utilized in calculating the time interval.

Non-Compliance Alarm

In one embodiment, when a determination unit determines that a second access to the temperature controlled compartment is not made within a time interval of a first access to the temperature controlled compartment, a signal generator generates a signal. In one embodiment, the signal is an audio signal. In another embodiment, the signal is a visual signal. In yet another embodiment, the signal is a tactile signal (e.g., vibration). In still another embodiment, the signal is odiferous. In another embodiment, the signal is electronic.

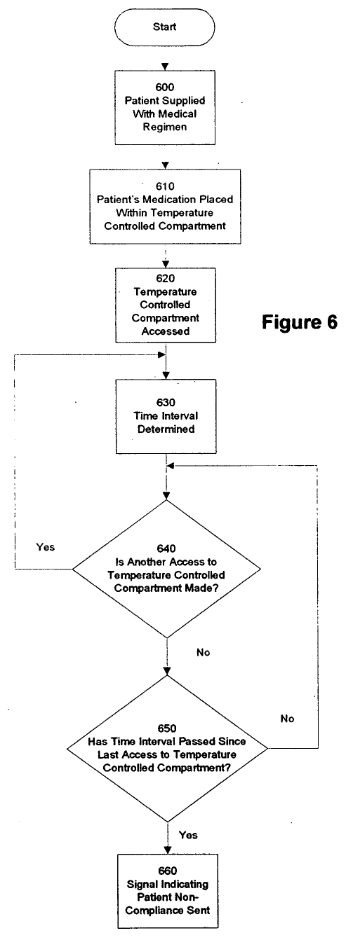

FIG. 6 illustrates the process of signaling patient non-compliance in accordance with one embodiment of the present invention. At block 600, a patient is supplied with a medical regimen. At block 610, the patient's medication is placed within the temperature controlled compartment. At block 620, the temperature controlled compartment is accessed. At block 630, a time interval is determined.

At block 640, it is determined whether another access to the temperature controlled compartment is made. If another access is made, the process repeats at block 630. If another access is not made, at block 650, it is determined whether the time interval has passed since the last access to the temperature controlled compartment. If the time interval since the last access has not passed, the process repeats at block 640. If the time interval since the last access has passed, at block 660, a signal indicating patient non-compliance is sent.

Notification of Patient Non-Compliance

In one embodiment, the signal is transmitted to a healthcare provider (e.g., a doctor, nurse, nurse practitioner, relative, herbalist, therapist, and/or other individual or organization that monitors a patient's compliance with a medical regimen or general health, etc., or two or more of any of the aforementioned healthcare providers). In one embodiment, the signal is transmitted via a computer network. In one embodiment, the signal is transmitted via the Internet. In still another embodiment, the signal is transmitted at least in part via a wireless connection.

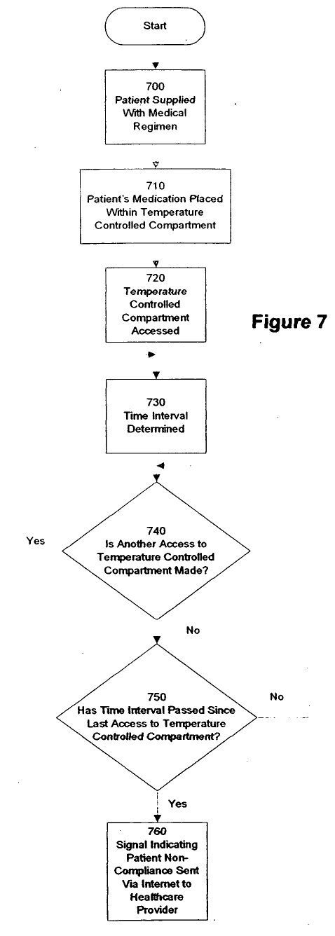

FIG. 7 illustrates the process of notifying a healthcare provider of a patient's non-compliance in accordance with one embodiment of the present invention. At block 700, a patient is supplied with a medical regimen. At block 710, the patient's medication is placed within the temperature controlled compartment. At block 720, the temperature controlled compartment is accessed. At block 730, a time interval is determined.

At block 740, it is determined whether another access to the temperature controlled compartment is made. If another access is made, the process repeats at block 730. If another access is not made, at block 750, it is determined whether the time interval has passed since the last access to the temperature controlled compartment. If the time interval since the last access has not passed, the process repeats at block 740. If the time interval since the last access has passed, at block 760, a signal indicating patient non-compliance is sent via the Internet to a healthcare provider.

In another embodiment, the signal is delivered at least in part to a speaker (e.g., a pre-recorded message sent telephonically to a healthcare provider's telephonic device). In one embodiment, the signal is delivered at least in part to a personal data assistant. In one embodiment, the signal is delivered to a device that analyzes the signal and takes an appropriate action (e.g., generating and transmitting additional signals). In various other embodiments, the signal is delivered via pager, switchboard monitoring center, instant messaging, electronic mail, cell phone, encrypted radio broadcast, dedicated connection, and/or any other electronic communications means. In one embodiment, the signal is delivered to a list containing at least one healthcare provider using one or more methods of transmission for each list item.

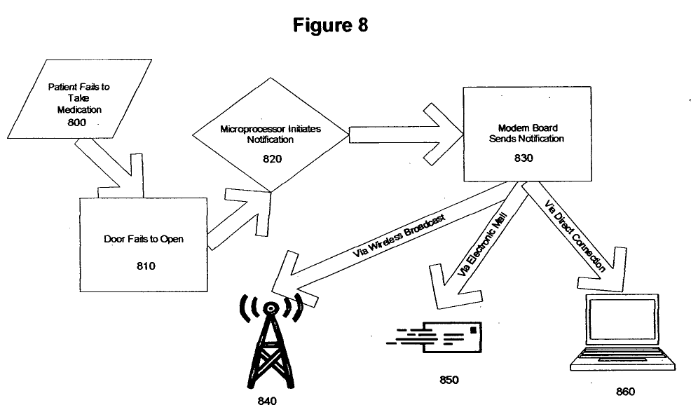

FIG. 8 illustrates the flow of occurrences involved in monitoring patient compliance with a medication regimen in accordance with one embodiment of the present invention. At block 800, a patient fails to take medication. As a result of the patient's failure and the fact that the medication is contained within a temperature controlled compartment, at block 810, the door fails to open within a predetermined time interval. Since the door fails to open within the predetermined time interval, at block 820, a microprocessor initiates a notification process. At block 830, a modem board associated with the system sends a notification of the failure via wireless broadcast 840, electronic mail 850, and/or direct connection 860.

Backup Power Supply

In one embodiment, a backup power supply is provided. In one embodiment, the backup power supply is a battery. In one embodiment, when a primary power source fails and the backup power source is in use, a signal is generated and transmitted in a manner similar to the signal generated when a second access to the temperature controlled compartment is not made within a time interval of a first access to the temperature controlled compartment.

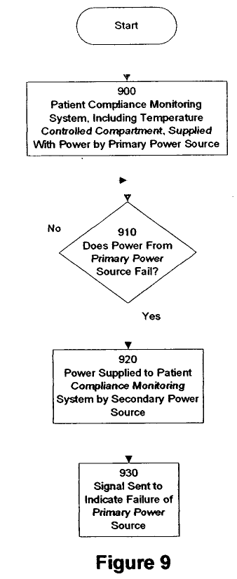

FIG. 9 illustrates the process of powering a patient compliance monitoring system in accordance with the present invention. At block 900, a patient compliance monitoring system, including a temperature controlled compartment, is supplied with power by a primary power source. At block 910, it is determined whether power from the primary power source fails. If power from the primary power source does not fail, the process repeats at block 910. If power from the primary power source fails, at block 920, power is supplied to the patient compliance monitoring system by a secondary power source. At block 930, a signal is sent to indicate failure of the primary power source.

Signals Other Than Non-Compliance Signals

In various other embodiments, signals are generated in addition to or instead of the signal indicating non-compliance by failure to access the temperature controlled compartment within a time interval of a previous access. In one embodiment, a signal is generated when a patient accesses the temperature controlled compartment within a minimum time interval. The signal may indicate the patient is medicating too frequently rather than too infrequently. In another embodiment, a signal is sent to inform a healthcare provider of a patient's compliance.

In one embodiment, a signal includes updated patient information (e.g., heart rate, blood pressure, blood oxygen level, weight, skin color information, or any other patient feature wherein a change in the feature value can be detected). In another embodiment, a signal indicates that an individual has not accessed any monitored regularly accessed device in accordance with that individual's normal access patterns, a condition that may indicate that the individual is in need of assistance (e.g., has fallen and can't get up, has succumbed to carbon monoxide, has had a heart attack, etc.).

### EXAMPLE EMBODIMENTS

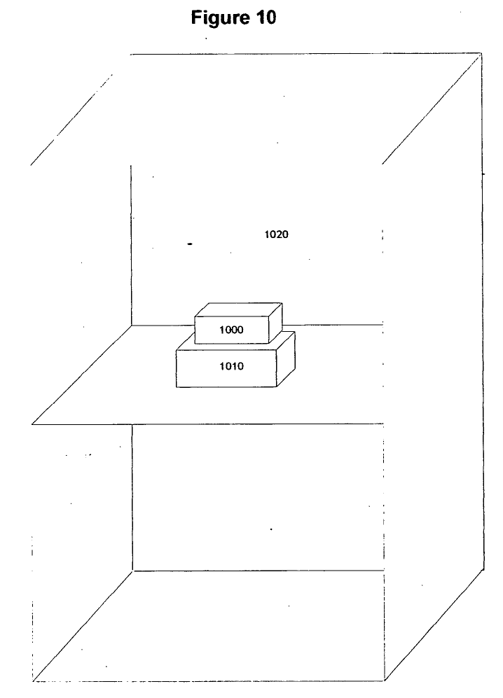

FIG. 10 illustrates an example embodiment wherein a temperature controlled compartment is placed within a typical household refrigerator in accordance with one embodiment of the present invention. The temperature controlled compartment 1000 is placed on a base 1010 within a refrigerator 1020. Temperature controlled compartment 1000 may be separated from base 1010 and removed from refrigerator 1020 in order to access the contents within temperature controlled compartment 1000.

To prevent access of temperature controlled compartment 1000 without removal from base 1010, temperature controlled compartment 1000 can only be accessed from the side adjacent to base 1010. Thus, when temperature controlled compartment 1000 is placed on base 1010, the contents of temperature controlled compartment 1000 cannot be accessed.

To ensure that temperature controlled compartment 1000 is returned to base 1010 after accessed to the contents, an alarm is generated when temperature controlled compartment 1000 is not returned to base 1010 within a time interval. To ensure that temperature controlled compartment 1000 is maintained at a correct temperature by refrigerator 1020, base 1010 monitors the surrounding temperature. Temperature controlled compartment 1000 is made at least partly of a poor thermal insulator so that the temperature within temperature controlled compartment 1000 is substantially the same as the temperature outside temperature controlled compartment 1000.

In operation, a patient places medication within temperature controlled compartment 1000, places base 1010 within refrigerator 1020, and connects temperature controlled compartment 1000 to base 1010. To access the medication, a patient detaches temperature controlled compartment 1000 from base 1010. A monitoring unit detects that base 1010 is separated from temperature controlled compartment 1000, indicating that the patient is taking a dose of the medication. A desired maximum time interval between this access and the next access is determined, a timer is initiated, and temperature controlled compartment 1000 is returned to base 1010 inside refrigerator 1020. If a patient fails to access temperature controlled compartment 1000 within the desired maximum time interval, a communication unit transmits the non-compliance information to a healthcare provider.

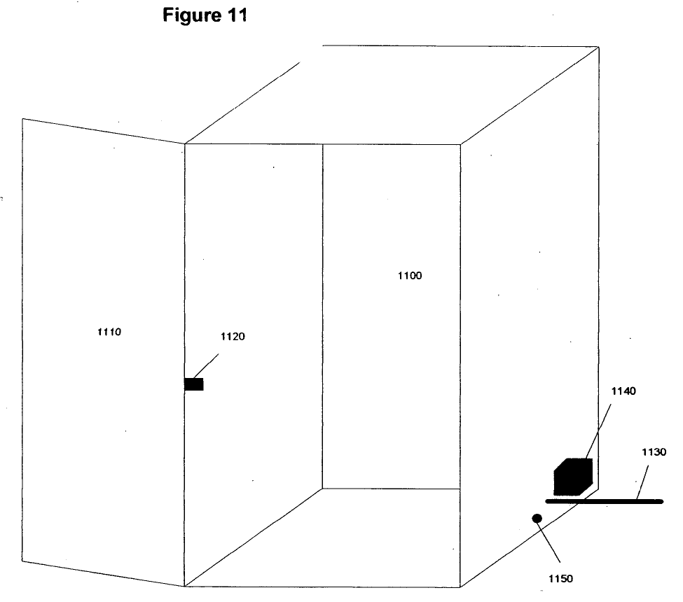

FIG. 11 illustrates an alternative example embodiment wherein the temperature controlled compartment need not be placed within a typical household refrigerator in accordance with one embodiment of the present invention. Temperature controlled compartment 1100 has its own thermal regulator to maintain the desired temperature within temperature controlled compartment 1100. Temperature controlled compartment is accessed by opening door 1110. When door 1110 is in an open position, door position switch 1120 is in an extended position, causing an electronic signal to indicate that door 1110 is open. When door 1110 is in a closed position, door position switch 1120 is in a retracted position, causing an electronic circuit to indicate that door 1110 is closed.

Temperature controlled compartment 1100 is attached to main power source 1130 (e.g., a standard household electrical outlet). Secondary power source 1140 is also connected to temperature controlled compartment 1100 so that the system can continue to operate in the event of a failure of main power source 1130. Additionally, communication connection 1150 (e.g., Ethernet connection, DSL connection, cable modem connection, etc.) is provided to enable transmission of non-compliance information and/or main power source failure.

In operation, a patient places medication within temperature controlled compartment 1100 and closes door 1110. To access the medication, a patient opens door 1110, causing door position switch 1120 to move into an extended position. A monitoring unit detects that door 1110 is open, indicating that the patient is taking a dose of the medication.

A desired maximum time interval between this access and the next access is determined, a timer is initiated, door 1110 is closed, and door position switch 1120 moves into a retracted position. If a patient fails to access temperature controlled compartment 1100 by opening door 1110 within the desired maximum time interval, a communication unit transmits the non-compliance information to a healthcare provider via communication connection 1150. Additionally, if power from main power source 1130 fails, the power supply is automatically switched to secondary power source 1140 and a power failure indication is sent to a healthcare provider via communication connection 1150.

Other Systems and Methods

Various embodiments of the present invention may be used in conjunction with some or all of other systems and/or methods such as those disclosed in U.S. Pat. Nos. 4,250,716; 6,294,999; 6,304,797; 6,332,100; 6,380,858; 6,462,660; 6,471,087; 6,529,446; 6,594,549; 6,615,107; 6,636,780, the disclosures of all of which are hereby incorporated by reference, and those disclosed in published U.S. patent applications Ser. Nos. 2002/0147526; 2003/0023146; 2003/0114736; 2003/0164754; and 2003/0189058, the disclosures of all of which are also hereby incorporated by reference.

### Embodiment of Computer Execution Environment (Hardware)

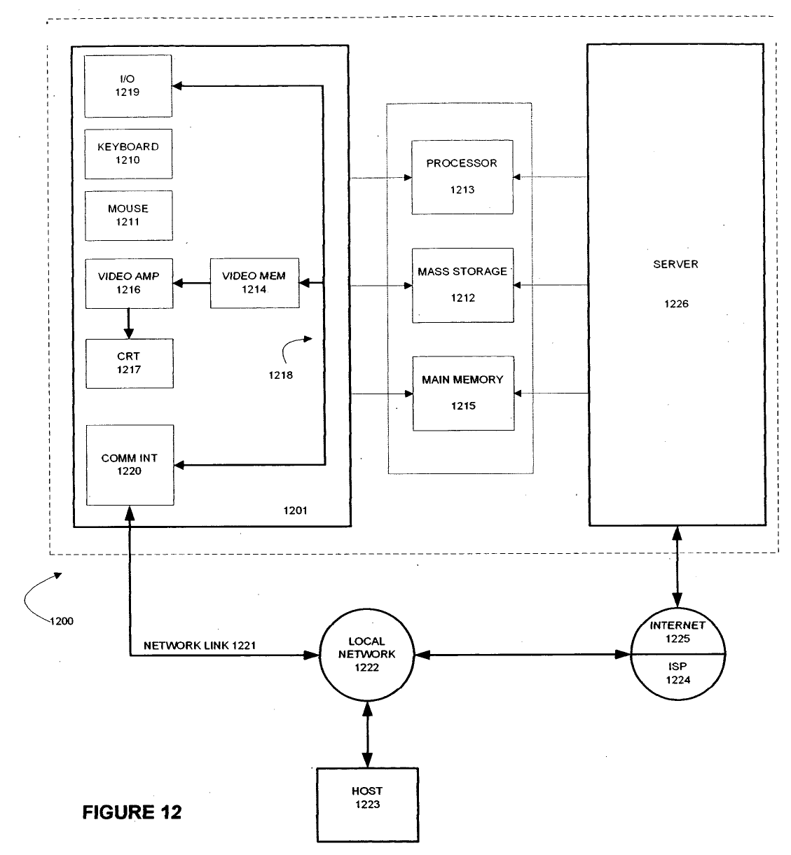

An embodiment of the invention can be implemented as computer software in the form of computer readable program code executed in a general purpose computing environment such as environment 1200 illustrated in FIG. 12. A keyboard 1210 and mouse 1211 are coupled to a system bus 1218. The keyboard and mouse are for introducing user input to the computer system and communicating that user input to central processing unit (CPU) 1213. Other suitable input devices may be used in addition to, or in place of, the mouse 1211 and keyboard 1210. I/O (input/output) unit 1219 coupled to bi-directional system bus 1218 represents such I/O elements as a printer, AN (audio/video) I/O, etc.

Computer 1201 may include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to local server computer 1223 or to data equipment operated by ISP 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1201, are exemplary forms of carrier waves transporting the information.

Processor 1213 may reside wholly on client computer 1201 or wholly on server 1226 or processor 1213 may have its computational power distributed between computer 1201 and server 1226. Server 1226 symbolically is represented in FIG. 12 as one unit, but server 1226 can also be distributed between multiple “tiers”. In one embodiment, server 1226 comprises a middle and back tier where application logic executes in the middle tier and persistent data is obtained in the back tier. In the case where processor 1213 resides wholly on server 1226, the results of the computations performed by processor 1213 are transmitted to computer 1201 via Internet 1225, Internet Service Provider (ISP) 1224, local network 1222 and communication interface 1220. In this way, computer 1201 is able to display the results of the computation to a user in the form of output.

Computer 1201 includes a video memory 1214, main memory 1215 and mass storage 1212, all coupled to bi-directional system bus 1218 along with keyboard 1210, mouse 1211 and processor 1213. As with processor 1213, in various computing environments, main memory 1215 and mass storage 1212, can reside wholly on server 1226 or computer 1201, or they may be distributed between the two.

The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as processor 1213, main memory 1215, video memory 1214 and mass storage 1212. Alternatively, multiplex data/address lines may be used instead of separate data and address lines.

In one embodiment of the invention, the microprocessor is manufactured by Intel, such as the 80×86 or Pentium-typed processor. However, any other suitable microprocessor or microcomputer may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1201 can send messages and receive data, including program code, through the network(s), network link 1221, and communication interface 1220. In the Internet example, remote server computer 1226 might transmit a requested code for an application program through Internet 1225, ISP 1224, local network 1222 and communication interface 1220. The received code may be executed by processor 1213 as it is received, and/or stored in mass storage 1212, or other non-volatile storage for later execution. In this manner, computer 1201 may obtain application code in the form of a carrier wave. Alternatively, remote server computer 1226 may execute applications using processor 1213, and utilize mass storage 1212, and/or video memory 1215. The results of the execution at server 1226 are then transmitted through Internet 1225, ISP 1224, local network 1222 and communication interface 1220. In this example, computer 1201 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for automatic health monitoring is described in conjunction with one or more specific embodiments. The invention is defined by the following claims and their full scope and equivalents.

1. A method for automatic health monitoring comprising the steps of:
providing a regularly accessed device;
detecting a first access to said regularly accessed device;
determining a time interval;
detecting a second access to said regularly accessed device; and
determining whether said second access is made within said time interval of said first access.

2. The method of claim 1 wherein said regularly accessed device is a temperature controlled compartment.

3. The method of claim 1 further comprising the step of:
signaling, if said second access is not made within said time interval of said first access.

4. The method of claim 3 wherein said step of signaling comprises the step of:
sending a signal to a healthcare provider.

5. The method of claim 4 wherein said step of sending comprises the step of:
transmitting said signal via a computer network.

6. The method of claim 1 further comprising the step of:
providing a backup power source configured to power said regularly accessed device.

7. An automatic health monitoring system comprising:
a regularly accessed device;
an access detection unit configured to detect a first access to said regularly accessed device wherein said access detection unit is further configured to detect a second access to said regularly accessed device;
a timer configured to monitor a time interval; and
a determination unit configured to determine whether said second access is made within said time interval of said first access.

8. The automatic health monitoring system of claim 7 wherein said regularly accessed device is a temperature controlled compartment.

9. The automatic health monitoring system of claim 7 further comprising:
a signal generator configured to signal, if said second access is not made within said time interval of said first access.

10. The automatic health monitoring system of claim 9 wherein said signal generator comprises:
a transmitter configured to send a signal to a healthcare provider.

11. The automatic health monitoring system of claim 10 wherein said transmitter transmits said signal via a computer network.

12. The automatic health monitoring system of claim 7 further comprising:
a backup power source configured to power said regularly accessed device.

13. A computer program product comprising:
a computer usable medium having computer readable program code embodied therein configured to automatically monitor health, said computer program product comprising:
computer readable code configured to cause a computer to interact with a regularly accessed device;
computer readable code configured to cause a computer to detect a first access to said regularly accessed device;
computer readable code configured to cause a computer to determine a time interval;
computer readable code configured to cause a computer to detect a second access to said regularly accessed device; and
computer readable code configured to cause a computer to determine whether said second access is made within said time interval of said first access.

14. The computer program product of claim 13 wherein said regularly accessed device is a temperature controlled compartment.

15. The computer program product of claim 13 further comprising:
computer readable code configured to cause a computer to signal, if said second access is not made within said time interval of said first access.

16. The computer program product of claim 15 wherein said computer readable code configured to cause a computer to signal comprises:
computer readable code configured to cause a computer to send a signal to a healthcare provider.

17. The computer program product of claim 16 wherein said computer readable code configured to cause a computer to send comprises:
computer readable code configured to cause a computer to transmit said signal via a computer network.

18. The computer program product of claim 13 further comprising:
computer readable code configured to cause a computer to interact with a backup power source configured to power said regularly accessed device.
